(19) United States
(12) Patent Application Publication
(10) Pub. No.: US 2005/0204352 A1
(43) Pub. Date: Sep. 15, 2005

(54) Method, system and software for synchronising multiple threads which are using a resource

(75) Inventor: M. George George, Bangalore (IN)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P.

(21) Appl. No.: 10/755,282

(22) Filed: Jan. 13, 2004

(51) Int. Cl. G06F 9/44

(52) U.S. Cl. 717/168; 717/100

(57) ABSTRACT

The present invention relates to a method, system and software for synchronising multiple threads which are using a resource. More particularly, but not exclusively, the present invention relates to a method for synchronizing multiple threads (2), which are using an implementation module (6), for the replacement of the implementation module (6). The method includes creating a plurality of private variables (1) corresponding to the plurality of threads (2), setting a replace module variable (5), and when the replace module variable is set (10) performing the steps of a) blocking (11) threads (12) from entering the implementation module (6); and b) when (13) all the private variables are in a reset state (14) replacing the implementation module (16). The use of locks within the performance path of the interface module is not required and threads and corresponding private variables are created and destroyed dynamically.

### FIELD OF INVENTION

The present invention relates to a method, system and software for synchronising multiple threads which are using a resource. More particularly, but not exclusively, the present invention relates to a method, system and software for synchronizing multiple threads, which are using an implementation module, for the replacement of the implementation module.

### BACKGROUND OF THE INVENTION

During the operation of a system, there can be a need to synchronise threads for events. If these events occur only rarely, adding mutual exclusion primitives provided by the system (such as mutexes, semaphores, etc., referred to as locks) can add significant performance overhead. More particularly, this is true for performance paths which are code paths that are executed very often during execution of a program.

When the system is a multi-threaded system and the event is the replacement of a software/firmware component, the process must ensure that the threads are synchronised so that no thread is within the component when it is replaced. Otherwise, there is a potential for new component functions to be incompatible with the current stack of the thread. This can result in incorrect program behaviour.

One process for replacing a software/firmware component during operation of the system is described in U.S. Pat. No. 6,154,878: System and method for on-line replacement of software.

Similarly, it is desirable that a process being migrated to a new system is not accessing system resources on the system from where it is being migrated. Otherwise, the system resources could be in an unstable state after the migration.

Using mutual exclusion primitives to synchronise the threads provided by the system (such as mutexes or semaphores) to ensure that the resource is not being used will severely affect performance, particularly if the resource is an interface library or if the resource is the operating system. If a counter is used, the counter has to be locked to increment the counter before using the resource and to decrement the counter after exiting the resource. If multiple threads need to use the resource concurrently, the counter must be unlocked after it is incremented or decremented. So effectively, every call to the interface library function could result in two calls to lock to increment and decrement and two calls to unlock after each lock. Therefore this design approach will result in four additional function calls (2 locks and 2 unlocks) per function call.

Other mutual exclusion methods are available which do not use locks within the performance path. These include Dekker's algorithm [1962] and Dijkstra's algorithm [1965].

These methods have the following disadvantages:
They are not designed for concurrency when the event is not taking place. So they serialize access to the resource.
They involve checking an array of variables in performance path and this will have high performance impact.
They are designed for operating with a known number of threads and consequently cannot be implemented for situations where threads are dynamically created and destroyed.

It is an object of the present invention to provide a method for synchronising multiple threads which overcomes the above disadvantages, or to at least provide the public with a useful choice.

### SUMMARY OF THE INVENTION

According to a first aspect of the invention there is provided a method of replacing an implementation module which is being accessed through an interface module by a plurality of threads from an application, including the steps of:
i) creating a plurality of private variables corresponding to the plurality of threads;
ii) setting a replace module variable;
iii) when the replace module variable is set:
   a. blocking threads from entering the implementation module; and
   b. when all the private variables are in a reset state, replacing the implementation module;
wherein the private variable is never in a reset state when the thread is within the implementation module, wherein the use of locks within the performance path of the interface module is not required, and wherein threads and corresponding private variables are created and destroyed dynamically.

The implementation module may be a non-recursive module.

Alternatively, the implementation module may be a recursive module. In which case the method may include the step of:
creating a plurality of counters variables corresponding to the plurality of threads.

Each counter may be readable and writeable only by its corresponding thread. The counter variable may be incremented every time its corresponding thread enters the implementation module and decremented every time the thread leaves the implementation module. The value of zero or below in the counter may correspond to the private variable being in a reset state and any value above zero may correspond to the private variable being in a set state.

It is preferred that step (iii) is performed within the interface module.

Preferably, each private variable is only writable by its corresponding thread. However, it is also preferred that each private variable is readable by all the threads.

The implementation module may be a library module.

It is preferred that the private variables and the replace module variable are cache coherent.

A thread may perform the step of (iii). It is preferred that a mutual exclusion primitive, such as a lock, is used within step (iii) to ensure that only one thread performs steps (a) and (b).

It is preferred that checking of flags within an array is not required in the performance path of the interface module.

According to a further aspect of the invention there is provided a method of synchronizing a plurality of threads for the performance of an action which affects a resource accessed within a portion of code, including the steps of:
i) registering for each thread a corresponding private variable;
ii) each thread setting the private variable when that thread enters the portion of code;
iii) setting a perform action variable when the action is to be performed;
iv) when a thread is within the portion of code and the perform action variable is set, the thread:
   a. resetting the private variable;
   b. when the private variables for all threads are not set:
      i. performing the action; and
      ii. resetting the perform action variable;
   c. setting the private variable; and
v) when a thread is within the portion of code and the perform action variable is reset, the thread:
   d. using the resource; and
   e. resetting the private variable;
wherein the threads may be dynamically created and destroyed.
   The method may include the step of:
when the thread has used the resource in step (v) and the perform action variable is set, the thread performing step (b).

It is preferred that the private variables and the perform action variable are cache coherent.

When a thread is performing the action in step (b), it is preferred that all other threads are blocked from performing step (b). The other threads may be blocked from performing step (b) by the use of a mutual exclusion primitive, such as a lock.

A thread may register its corresponding private variable. The registration of the private variable may occur when the thread is created or when it enters the interface module for the first time.

When a thread is destroyed it is preferred that its corresponding private variable is deregistered.

It is preferred that locks within the performance path of the portion of code are not required.

The resource may be the kernel or operating system of a machine upon which a process containing the threads is running. In which case, the action may be the migration of the process to a new machine.

The resource may be an implementation module. In which case, the portion of code may be within an interface module for the implementation module, and the action may be the replacement of the implementation module.

According to a further aspect of the invention there is provided an interface module for an implementation module, including:
i) a plurality of private variables for correspondence to a plurality of threads, each private variable to be readable by all threads and writable only by the corresponding thread, and each private variable arranged to be in a SET state or a RESET state;
ii) a replace module variable; and
iii) program code arranged for registering the privates variables for created threads, deregistering the private variables for destroyed threads, blocking threads from entering the implementation module, and replacing the implementation module when all the registered private variables are in a RESET state;
wherein the use of locks within the performance path of the interface module is not required and the threads are dynamically created and destroyed.

According to a further aspect of the invention there is provided a system for replacing an implementation module, including:
i) a memory which stores a plurality of private variables corresponding to a plurality of threads;
ii) a memory which stores a replace module variable; and
iii) a processor arranged for registered the private variables for created threads, deregistering privates variables for destroyed threads, setting and resetting the registered private variables when instructed by the corresponding thread, setting the replace module variable, and when the replace module variable is set:
   a. blocking entry of threads to the implementation module; and
   b. when all the registered private variables are in a reset state, replacing the implementation module;
wherein the threads are dynamically created and destroyed.

The processor may be further arranged for resetting the replace module variable when the implementation module has been replaced. The processor may be further arranged for unblocking the threads when the replace module variable has been reset.

### BRIEF DESCRIPTION OF THE DRAWINGS

Embodiments of the invention will now be described, by way of example only, with reference to the accompanying drawings in which:

FIG. 1: shows a diagram illustrating how a first thread uses the implementation module.

FIG. 2: shows a diagram illustrating how a second thread is blocked from using the implementation module when the replace variable is set.

FIG. 3: shows a diagram illustrating how the first thread replaces the implementation module.

FIG. 4: shows a diagram illustrating how the second thread is unblocked and allowed to use the replaced implementation module.

### DETAILED DESCRIPTION OF PREFERRED EMBODIMENTS

The present invention describes a method of ensuring the implementation module is not in use by any threads before it is replaced without using locks in the performance paths of the interface module. For the purposes of this description, “performance path” is defined as the code path in an interface module that is always used during a call to a function in the implementation module.

It will be appreciated that, with appropriate modifications, the invention may be used to synchronise multiple threads to perform any action which affects any resource utilised by the threads.

In this description the invention is described wherein the resource is an implementation module and the action affecting the resource is replacement of the implementation module.

It will be appreciated that the resource affected could be the kernel or operating system resources used by a process of the system. The action that affects the resource in this instance may be the migration of the entire process from one machine to another.

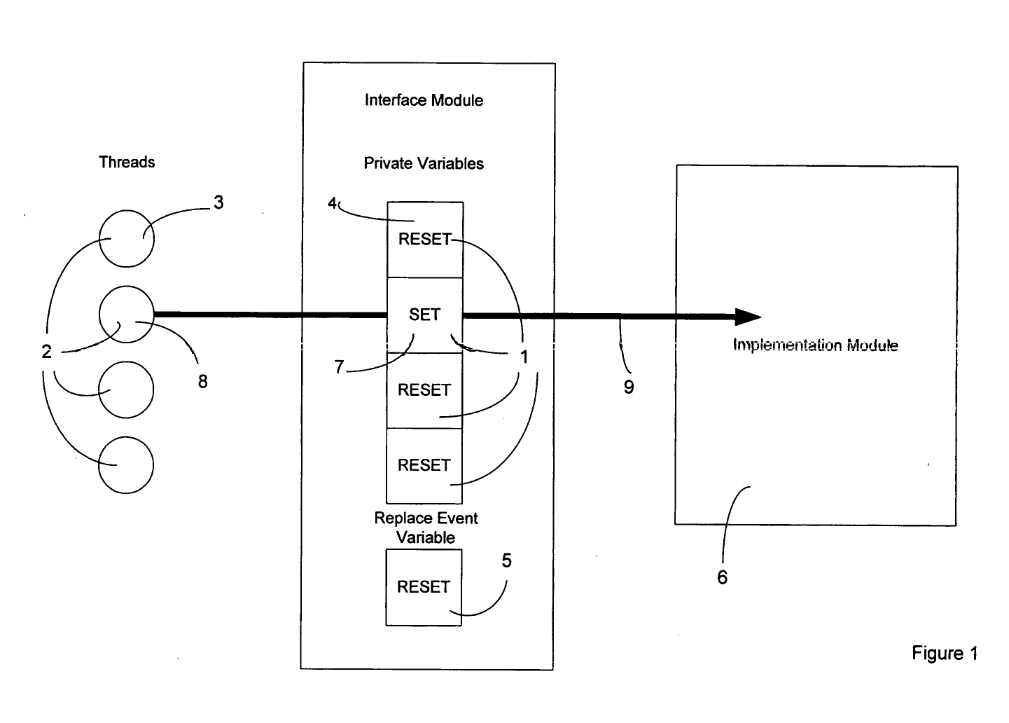

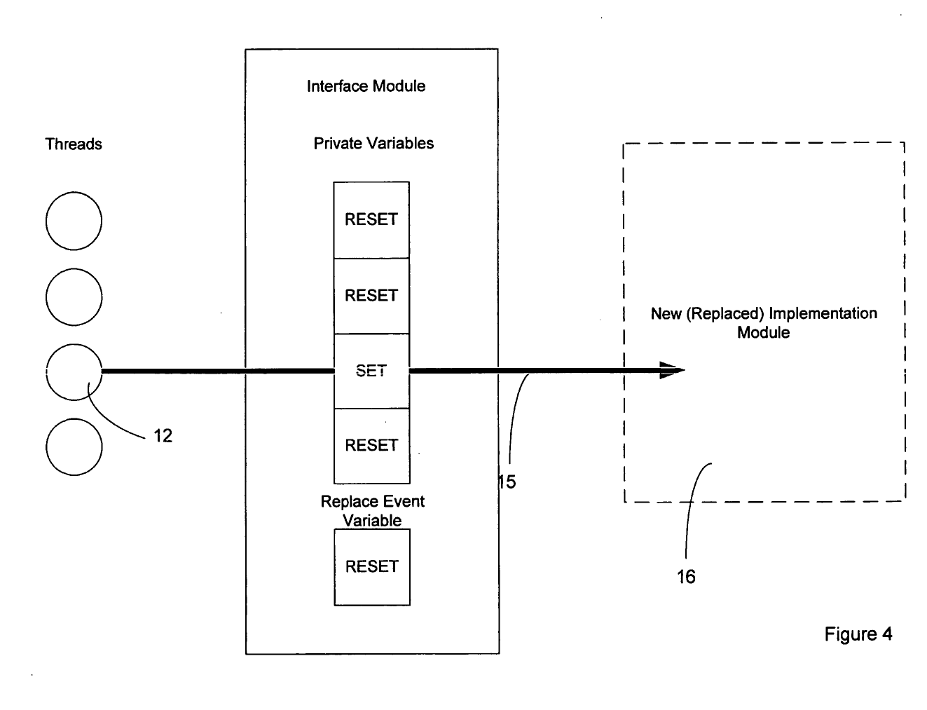

With reference to FIGS. 1 to 4 the method of the invention will be described.

The method of the invention uses a “private_variable” 1 for each thread 2. The memory allocated for the “private_variable” can be one or more bits. While a thread 3 can modify (write) only its own “private_variable” 4, all threads can read all “private_variable”s 1.

A global “replace_event_variable” 5 is provided for one or more implementation modules 6. The “replace_event_variable” 5 indicates whether module replacement of the implementation module/s is to be initiated. All implementation module/s that share one “replace_event_variable” will be replaced together.

The “private_variable” is SET 7 (one or more values may correspond to SET) when the thread 8 uses 9 the implementation module 6. When the “replace_event_variable” is set 10, the method blocks 11 any new entries by threads 12 into the implementation module 6. The method checks 13 that all “private_variable”s 14 are in RESET (a value that does not correspond to SET) before replacement. This ensures that the implementation modules being replaced are not in use.

The method described applies when the resource is a non-recursive resource. A non-recursive resource is one where a thread is not permitted to use the resource again until previous usage by the thread is complete. Multiple threads are, however, permitted to use the resource concurrently. Library or operating system functions are non-recursive resources with respect to the user thread.

The method may be adapted for use with recursive resources—resources where the thread can externally call multiple functions, or multiple instances of the same function, of the resource at any one time. In order to utilise the method for recursive resources the following steps need to be performed:
1) Create a plurality of counters variables corresponding to the plurality of threads. Each counter is readable and writeable only by its corresponding thread
2) Increment the counter every time a thread enters an implementation function and decrement it every time it leaves an implementation function. Any value above zero corresponds to SET and any other value corresponds to RESET.

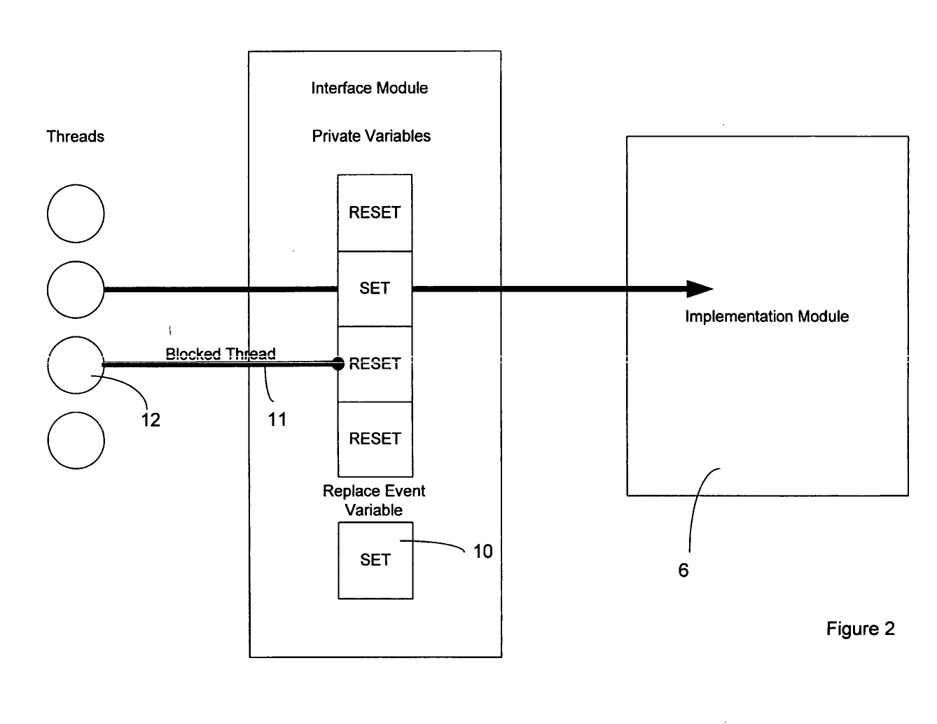

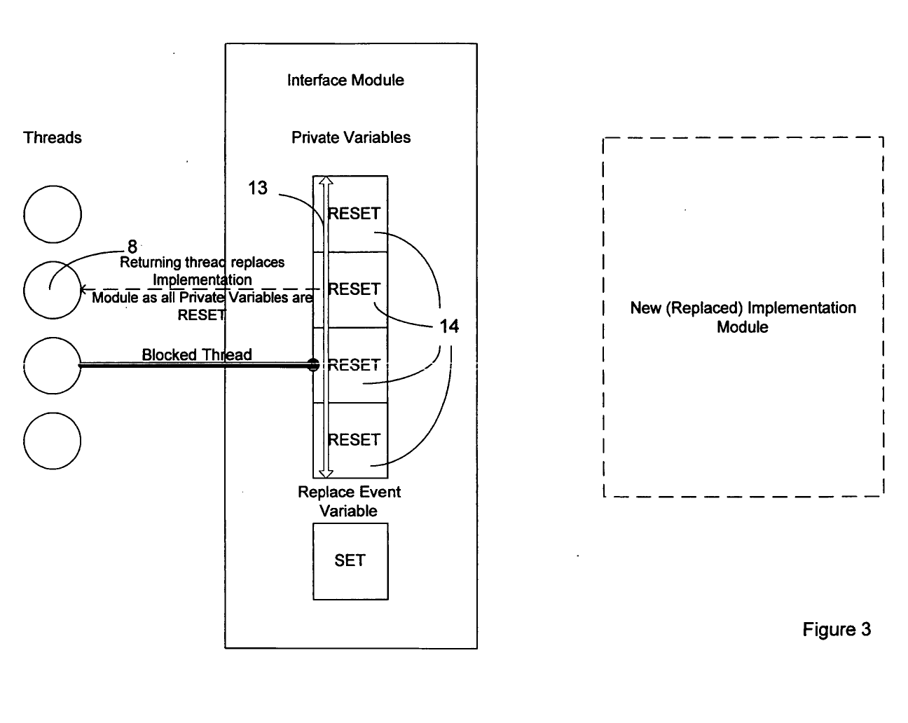

In FIG. 3, it is a thread exiting the implementation module 8 which checks 13 (see FIG. 2) that all the “private_variables” are in RESET. This thread 8 will then undertake the replacement procedure.

Threads 12 that were blocked 11 while the implementation module was waiting to be replaced are unblocked, and permitted to continue their entry 15 into, what is now, the replacement implementation module 16.

Locks are used to register “private_variable”s from new threads (created) and to deregister “private_variables” from threads that are ending (destroyed). The threads can be created and destroyed dynamically over the course of system execution.

Locks are also used when checking the private variables to establish that they are in RESET and when replacing the implementation module.

It will be appreciated that mutual exclusion primitives other than locks may be used.

An example of the method will now be described.

“ABC(xxx)” is a function in interface module corresponding to function “XYZ(xxx)” in the implementation library. This example assumes the system ensures cache coherency for both the “private_variable”s and the “replace_event_variable”. For systems that are not normally cache coherent, these variables must be defined as cache coherent.

Cache coherency means that the “private_variable”s and the “replace_event_variable” are synchronised between multiple caches so that reading a memory location via any cache will return the most recent variable written to that location via any (other) cache.

Pseudo-code to implement the example is provided below:

ABC(int xxx)
{

/* THIS IS THE PERFORMANCE PATH */
..
if (new thread)
{

/* CALLED ONLY ONCE PER THREAD. INSIDE “if” IS NOT PERFORMANCE

PATH */

Lock( );
Register “private_variable”;
/* “REGISTERING” CAUSES THIS VARIABLE TO BE CHECKED BEFORE THE

IMPLEMENTATION

* MODULE IS REPLACED. SINCE REGISTRATION IS DONE UNDER LOCK IT

ENSURES THAT

* NEWLY ADDED THREADS DO NOT CAUSE THE ALGORITHM TO FAIL
*/
Unlock( );

}
SET “private_variable”;
While (“replace_event_variable” is SET)
{

/* WE REACH HERE ONLY IF MODULE IS TO BE REPLACED. SO THIS IS

NOT PERFORMANCE

* PATH.
* THIS THREAD IS NOT IN THE IMPLEMENTATION LIBRARY. SO IT IS

SAFE TO

* RESET “private_variable”
*/
RESET “private_variable”;
Call function Replace_Implementation_Library( );
/* THE WHILE LOOP BELOW BLOCKS UNTIL MODULE IS REPLACED */
while (“replace_event_variable” is set) Loop or Sleep or Block;
SET “private_variable”;

}
/* THE “private_variable” IS SET WHEN THIS PART IS REACHED */
Call function XYZ(xxx) corresponding to ABC(xxx) in the

implementation library;

/* THE THREAD IS OUT OF IMPLEMENTATION LIBRARY. SO IT IS SAFE TO

RESET

* “private_variable”;
*/
RESET “private_variable”;
/* NOT CHECKING “replace_event_variable” HERE CAN CAUSE DEADLOCK */
If (“replace_event_variable” is set) Call function

Replace_Implementation_Library( ); ..
}
Replace_Implementation_Library( )
{

/* THIS FUNCTION IS NOT CALLED IN PERFORMANCE PATH */
Lock( )
/* ENSURE THAT ANOTHER THREAD HAS NOT RESET “replace_event_variable”

*/

If ((“replace_event_variable” is SET)
{

/* ENSURE THAT NO THREAD IS IN IMPLEMENTATION LIBRARY */
for (“private_variable” of every thread)
{

if (“private_variable” is set)
{

/* THERE COULD BE SOME THREADS IN IMPLEMENTATION

LIBRARY.

* SO RETURN
*/
Unlock( );
return;

}

}
/* ALL (“private_variable”s ARE CHECKED AND THERE ARE NO THREADS
* IN IMPLEMENTATION LIBRARY
*/
Unload implementation libraries;
Load new implementation libraries;
/* MODULE IS REPLACED - RESET THE “replace_event_variable” */
RESET “replace_event_variable”;

}
Unlock( );

}
/* THE FOLLOWING FUNCTION IS CALLED WHEN ANY OF THE THREADS ENDS OR ARE
TERMINATED */
Thread_cancel_callback( )
{

RESET “private_variable”;
If (“replace_event_variable” is SET)

Call function Replace_Implementation_Library( );

Lock( );
/* THE PRIVATE VARIABLE OF THIS THREAD NEED NOT BE CHECKED ANYMORE

*/

Deregister “private_variable”;
Unlock( )

}

The advantage of the present invention is that it provides a method “without locks in the performance path” that is capable of operating with a dynamically changing number of threads/processes and any number of threads/processes. Existing mutual exclusion algorithms without locks are inefficient as the maximum number of threads/processes increases. The present invention permits registration of threads which use the resource/module and deregistration of the threads when the thread is cancelled, thus keeping the algorithm optimal.

A further advantage is that the method does not have locks or “checking flags in an array” in the performance path. This makes the invention unique and suitable for performance paths that do not normally require mutual exclusion.

While the present invention has been illustrated by the description of the embodiments thereof, and while the embodiments have been described in considerable detail, it is not the intention of the applicant to restrict or in any way limit the scope of the appended claims to such detail. Additional advantages and modifications will readily appear to those skilled in the art. Therefore, the invention in its broader aspects is not limited to the specific details representative apparatus and method, and illustrative examples shown and described. Accordingly, departures may be made from such details without departure from the spirit or scope of the applicant's general inventive concept.

1. A method of replacing an implementation module which is being accessed through an interface module by a plurality of threads from an application, including the steps of:
i) creating a plurality of private variables corresponding to the plurality of threads;
ii) setting a replace module variable;
iii) when the replace module variable is set:
a. blocking threads from entering the implementation module; and
b. when all the private variables are in a reset state, replacing the implementation module;
wherein the private variable is never in a reset state when the thread is within the implementation module, wherein the use of locks within the performance path of the interface module is not required, and wherein threads and corresponding private variables are created and destroyed dynamically.

2. A method as claimed in claim 1 wherein the implementation module is a non-recursive module.

3. A method as claimed in claim 1 wherein the implementation module is a recursive module.

4. A method as claimed in claim 3 including the step of:
creating a plurality of counter variables corresponding to the plurality of threads;
wherein each counter is incremented when the corresponding thread enters the implementation module and decremented when the thread exits the implementation module.

5. A method as claimed in claim 4 wherein the private variable is in a set state when the value of the counter is above zero and the private variable is in a reset state when the value of the counter is zero or below.

6. A method as claimed in claim 5 wherein each counter is only readable and writable by its corresponding thread.

7. A method as claimed in claim 1 wherein step (iii) is performed by the interface module.

8. A method as claimed in claim 7 wherein each private variable is modifiable by that variable's corresponding thread.

9. A method as claimed in claim 8 wherein each private variable is readable by all the threads.

10. A method as claimed in claim 9 wherein the implementation module is a library.

11. A method as claimed in claim 1 wherein the private variables and the replace module variable are defined as cache coherent.

12. A method as claimed in claim 1 wherein a thread performs the step (iii).

13. A method as claimed in claim 12 wherein a mutual exclusion primitive is used within step (iii) to ensure that only a single thread performs steps (a) and (b).

14. A method as claimed in claim 1 wherein checking of flags within an array is not required in the performance path of the interface module.

15. A method of synchronizing a plurality of threads for the performance of an action which affects a resource accessed within a portion of code, including the steps of:
i) registering for each thread a corresponding private variable;
ii) each thread setting the private variable when that thread enters the portion of code;
iii) setting a perform action variable when the action is to be performed;
iv) when a thread is within the portion of code and the perform action variable is set, the thread:
a. resetting the private variable;
b. when the private variables for all threads are not set:
i. performing the action; and
ii. resetting the perform action variable;
c. setting the private variable; and
v) when a thread is within the portion of code and the perform action variable is reset, the thread:
d. using the resource; and
e. resetting the private variable;
wherein the threads may be dynamically created and destroyed.

16. A method as claimed in claim 15 wherein the use of locks within the performance path of the portion of code is not required.

17. A method as claimed in claim 16 including the step of:
when the thread has used the resource in step (v) and the perform action variable is set, the thread performing step (b).

18. A method as claimed in claim 16 wherein the private variables and the perform action variable are cache coherent.

19. A method as claimed in claim 16 wherein when a thread is performing the action in step (b), all other threads are blocked from performing step (b).

20. A method as claimed in claim 19 wherein the other threads are blocked by use of a mutual exclusion primitive.

21. A method as claimed in claim 16 wherein each thread registers their corresponding private variable.

22. A method as claimed in claim 21 wherein the registration of each private variable occurs when the corresponding thread is created.

23. A method as claimed in claim 21 wherein the registration of each private variable occurs when the corresponding thread enters the interface module for the first time.

24. A method as claimed in claim 16 wherein a private variable is deregistered when its corresponding thread is destroyed.

25. A method as claimed in claim 16 wherein the resource is the kernel or operating system of a machine upon which a process containing the threads is operating and the action is the migration of the process to a new machine.

26. A method as claimed in claim 16 wherein the resource is an implementation module, the portion of code is an interface module for an implementation module and the action is the replacement of the implementation module.

27. An interface module for an implementation module, including:
i) a plurality of private variables for correspondence to a plurality of threads, each private variable to be readable by all threads and writable only by the corresponding thread, and each private variable arranged to be in a SET state or a RESET state;
ii) a replace module variable; and
iii) program code arranged for registering the privates variables for created threads, deregistering the private variables for destroyed threads, blocking threads from entering the implementation module, and replacing the implementation module when all the registered private variables are in a RESET state;
wherein the use of locks within the performance path of the interface module is not required and the threads are dynamically created and destroyed.

28. A system for replacing an implementation module, including:
i) a memory which stores a plurality of private variables corresponding to a plurality of threads;
ii) a memory which stores a replace module variable; and
iii) a processor arranged for registered the private variables for created threads, deregistering privates variables for destroyed threads, setting and resetting the registered private variables when instructed by the corresponding thread, setting the replace module variable, and when the replace module variable is set:
a. blocking entry of threads to the implementation module; and
b. when all the registered private variables are in a reset state, replacing the implementation module;
wherein the threads are dynamically created and destroyed.

29. A system as claimed in claim 28 wherein the processor is further arranged for resetting the replace module variable when the implementation module has been replaced.

30. A system as claimed in claim 29 wherein the processor is further arranged for unblocking the threads when the replace module variable has been reset.

31. A computer system for performing the method of claim 1.

32. A computer system for performing the method of claim 15.

33. Software for performing the method of claim 1.

34. Software for performing the method of claim 15.

35. Storage media containing software as claimed in claim 33.

36. Storage media containing software as claimed in claim 34.
